(19) United States
(12) Patent Application Publication
(10) Pub. No.: US 2008/0169999 A1
(43) Pub. Date: Jul. 17, 2008

(54) Dielectric layer comprising organic material, method of forming the dielectric layer, and plasma display panel comprising the dielectric layer

(75) Inventors: Eun-hee Kim, Yongin-si (KR); Woo-suk Choi, Yongin-si (KR); Jin-woo Lee, Yongin-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/881,874

(22) Filed: Jul. 30, 2007

(30) Foreign Application Priority Data
Jan. 16, 2007 (KR) 10-2007-0004960

(51) Int. Cl. G09G 3/28

(52) U.S. Cl. 345/60

(57) ABSTRACT

A dielectric layer of a plasma display panel that can coat a discharge electrode regardless of the form of the discharge electrode and that can be manufactured using a low temperature process, a method of forming the dielectric layer, and a plasma display panel including the dielectric layer. Thus the dielectric layer includes an organic material and is manufactured using an electro-deposition coating method.

### CROSS-REFERENCE TO RELATED PATENT APPLICATION

This application claims the benefit of Korean Patent Application No. 10-2007-0004960, filed on Jan. 16, 2007 in the Korean Intellectual Property Office, the disclosure of which is incorporated herein in its entirety by reference.

### BACKGROUND OF THE INVENTION

1. Field of the Invention

The present invention relates generally to a dielectric layer of a plasma display panel (PDP) and relates more specifically to such a dielectric layer that includes an organic material, a method of forming the dielectric layer using an electro-deposition coating method, and a plasma display panel comprising the dielectric layer.

2. Description of the Related Art

Plasma display panels (PDP) display desired images using visible rays generated by sealing discharge gas and applying a discharge voltage between two substrates on which a plurality of electrodes are formed to generate vacuum ultraviolet rays and exciting phosphor on which the vacuum ultraviolet rays are formed in a predetermined pattern. Because of their thin, lightweight structure, PDPs are regarded as next generation display devices.

Inactive discharge gas is changed into a plasma state by applying high frequency voltage to the electrodes, thereby generating the vacuum ultraviolet rays which excite the phosphor, thus realizing images.

The plasma state includes charged particles by ionizing inactive gas; however, the electrodes may be damaged by the charged particles. Thus, a dielectric layer is formed to surround the electrodes to prevent collisions between the charged particles and the electrodes.

A conventional dielectric layer is formed by depositing an inorganic material on a discharge electrode. However, when an opening portion is formed in a discharge electrode, it is difficult to deposit the inorganic material on the inner surface of the opening portion and even when the inorganic material is deposited on the inner surface of the opening portion it is difficult to uniformly deposit the inorganic material.

In addition, a high temperature plasticizing process must be performed on a dielectric layer formed of inorganic material, and thus a substrate of a PDP containing the dielectric layer can only be formed of glass which can endure high temperature. Thus, it is difficult to manufacture a light and flexible plasma display panel.

### SUMMARY OF THE INVENTION

The present invention provides a dielectric layer that can coat electrodes regardless of the form of the electrodes and that can be formed using a low temperature process, and a method of forming such a dielectric layer.

The present invention also provides a plasma display panel with improved reliability and which can be more easily manufactured.

According to an aspect of the present invention, there is provided a dielectric layer of a plasma display panel which is formed on a discharge electrode and includes an organic material.

The dielectric layer of the plasma display panel restricts discharge current to maintain a glow discharge and reduces memory performance and voltage by accumulating wall charges, and protects the electrodes from collision with charged particles.

The organic material may be formed of polyimide, polyacryl, urea, melanine, or epoxy. Also, since the inside temperature during the discharge of the plasma display panel is increased to about 150° C., the organic material, which has a glass transition temperature Tg of at least 150° C. may have greater thermal stability,

According to another aspect of the present invention, there is provided a method of forming a dielectric layer of a plasma display panel on a discharge electrode using an electro-deposition coating method.

The electro-deposition coating method electrically deposits an organic material to a material to be electro-deposited in the same manner as electro-plating. The electro-deposition coating method may comprise: forming a composition for electro-deposition by mixing a counter-agent with an organic material; immersing the discharge electrode and a counter-electrode facing the discharge electrode in the composition; applying a voltage to the discharge electrode and the counter-electrode, respectively; and electro-depositing the organic material on the discharge electrode.

When forming the composition for electro-deposition by mixing the counter-agent with the organic material, the composition for electro-deposition may be formed by mixing 0.001-4.000 parts by weight of an organic material and 0.001-4.000 parts by weight of a counter-agent in a solvent.

The organic material may be one selected from the group consisting of polyimide, polyacryl, urea, melanine, and epoxy.

The counter-agent charges the organic material temporarily and may be acryl.

The method may further comprise hardening the electro-deposited organic material. The hardening may be performed at a temperature in the range of 50-250° C. at least once.

According to another aspect of the present invention, there is provided a plasma display panel comprising: first and second substrates separated from each other; a plurality of discharge electrodes to which a predetermined voltage is applied to generate discharge in a discharge space between the first and second substrates; a dielectric layer that is formed to cover the discharge electrodes and comprises an organic material; and a phosphor layer located in the discharge space.

The organic material may be one selected from the group consisting of polyimide, polyacryl, urea, melanine, and epoxy.

The discharge electrodes may comprise sustain discharge electrode pairs arranged parallel to each other on the first substrate and extending in a first direction, and the dielectric layer may be formed on the first substrate to cover the sustain discharge electrode pairs. The discharge electrodes may comprise sustain discharge electrode pairs disposed between the first and second substrates, and the dielectric layer may be formed on the sustain discharge electrode pairs. Here, when an opening portion is formed in each of the sustain discharge electrodes, the dielectric layer may be formed to coat the inner surface of the opening portion of each of the sustain discharge electrodes. The discharge electrodes may comprise an address electrode extending in a second direction to which a voltage is applied to generate address discharge, and the dielectric layer is formed to cover the address electrode.

### BRIEF DESCRIPTION OF THE DRAWINGS

The above and other features and advantages of the present invention will become more apparent from the following detailed description of exemplary embodiments thereof with reference to the attached drawings in which:

FIG. 1 is a schematic view illustrating an electro-deposition apparatus for forming a dielectric layer of a plasma display panel according to an embodiment of the present invention;

FIGS. 2 and 3 are schematic views illustrating an electrochemical reaction occurring in an anode and a cathode of the electro-deposition apparatus illustrated in FIG. 1;

FIG. 4 is a sectional perspective view illustrating a plasma display panel according to an embodiment of the present invention;

FIG. 5 is a partially cut perspective view illustrating a plasma display panel according to another embodiment of the present invention;

FIG. 6 is an extended perspective view illustrating sustain discharge electrode pairs of the plasma display panel illustrated in FIG. 5, according to an embodiment of the present invention;

FIG. 7 is a cross-sectional view illustrating the plasma display panel of FIG. 5, according to an embodiment of the present invention;

FIGS. 8 and 9 are photographic images showing the plasma display panel of FIG. 4 before forming a dielectric layer and after forming a dielectric layer, respectively; and

FIGS. 10 and 11 are photographic images showing the plasma display panel of FIG. 5 before forming a dielectric layer and after forming a dielectric layer, respectively.

### DETAILED DESCRIPTION OF THE INVENTION

The present invention will now be described more fully with reference to the accompanying drawings, in which exemplary embodiments of the invention are shown.

<Manufacturing of Composition for Electro-Deposition>

0.001-4.000 parts by weight of polyimide (1) and 0.001-4.000 parts by weight of acryl (2), which is a counter-agent, were added to 15 to 40 parts by weight of a mixture of N-Methylpyrrolidone (NMP) and cyclohexanone (CHN) and 60 parts or more of water to form a composition for electro-deposition.

Accordingly, as represented in Formula 1 below, polyimide (1) and acryl (2) and water were reacted and thus a water-soluble composition (3) for electro-deposition was formed. The size of particles of the water-soluble composition (3) for electro-deposition was controlled from 0.01 to 0.2 μm.

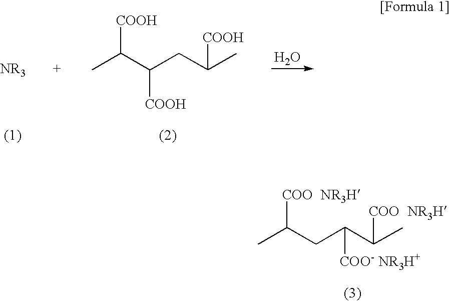

In Formula 1, R is a functional group containing carbon (C), oxygen (O), and hydrogen (H).

<Electro-Deposition Process>

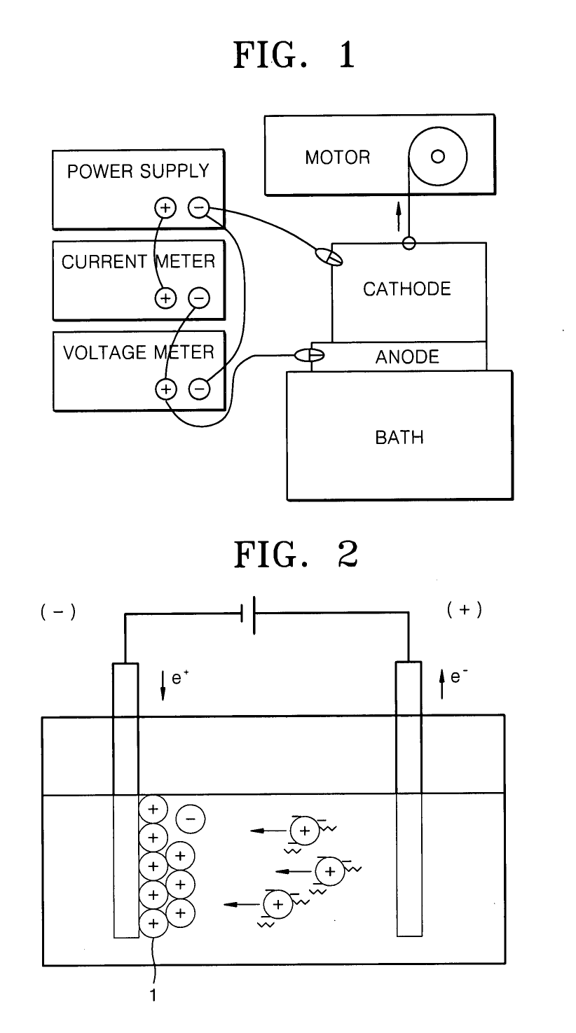

FIG. 1 is a schematic view illustrating an electro-deposition apparatus for forming a dielectric layer of a plasma display panel (PDP) according to an embodiment of the present invention. Referring to the electro-deposition apparatus illustrated in FIG. 1, a power supply, a current meter, and a voltage meter are connected to one another.

The power supply is connected to each of the current meter and the voltage meter, a negative pole of the power supply is connected to a discharge electrode corresponding to a cathode of FIG. 1, and a positive pole of the power supply is connected to a counter-electrode corresponding to an anode of FIG. 1.

Particularly, the positive pole of the power supply is connected to a positive pole of the current meter, a negative pole of the current meter is connected to a positive pole of the voltage meter, and a negative pole of the voltage meter is connected to the discharge electrode corresponding to the anode of FIG. 1.

The discharge electrode is used as a sustain discharge electrode of a plasma display panel and thus may be formed of copper (Cu), aluminium (Al), or silver (Ag). The counter-electrode faces the discharge electrode and may be formed of a less reactive metal than the discharge electrode, for example, steel use stainless (SUS). In the current embodiment of the present invention, positively-charged polyimide is used as a composition for electro-deposition to connect the discharge electrode to the cathode, but the present invention is not limited thereto, and the discharge electrode can be connected to the anode according to the type of the organic material and the counter-agent.

Also, the electro-deposition apparatus includes a bath into which the composition for electro-deposition is filled. The discharge electrode and the counter-electrode are immersed in the composition for electro-deposition in the bath. Such immersion is performed using a motor.

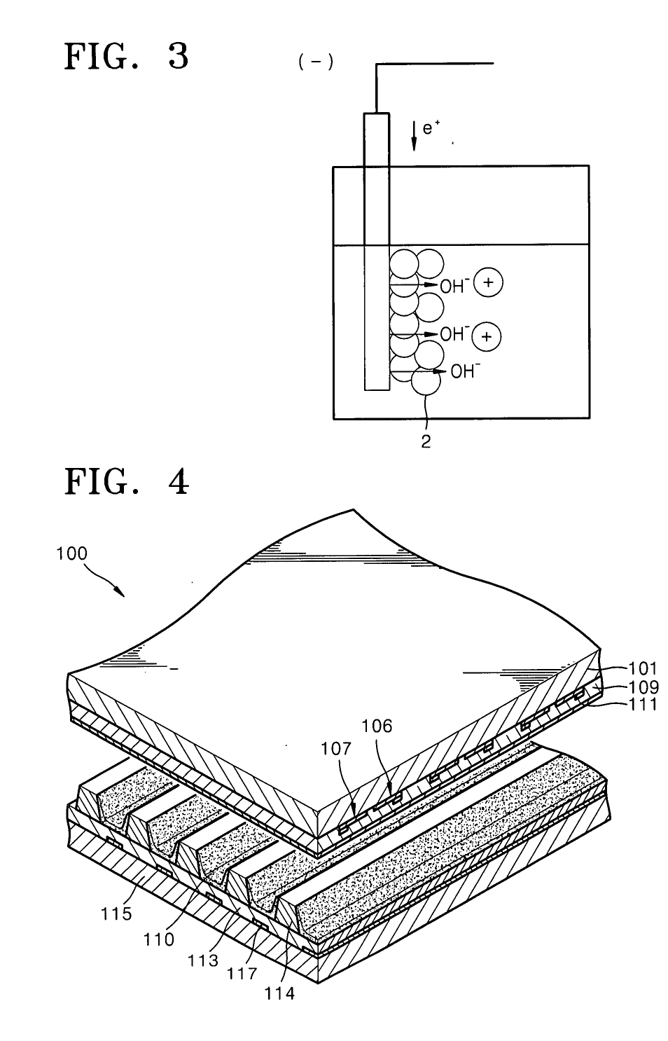

FIGS. 2 and 3 are schematic views illustrating an electrochemical reaction occurring in the anode and the cathode of the electro-deposition apparatus illustrated in FIG. 1. Referring to FIGS. 2 and 3, polyimide is extracted on the surface of the discharge electrode at the cathode (−). In detail, according to Formulas 2 and 3, electrons (e) are added to water (H₂O) to form hydrogen gas (H₂) and hydroxide ion (OH⁻) on the surface of the discharge electrode. Thus the water becomes alkaline, and the hydroxide ions (OH⁻) are bonded to the polyimide (1) that is positively charged, and thus polyimide (2) is extracted on the discharge electrode and water (H₂O) is formed.

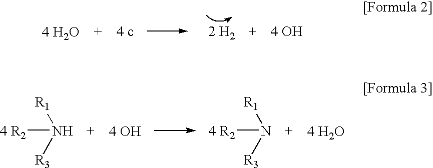

In Formula 3, R₁, R₂, and R₃ are functional groups containing carbon (C), oxygen (O), and hydrogen (H).

Also, according to Formulas 4 and 5 below, the surface of the anode (+), that is, the counter-electrode emits oxygen gas (O₂) and hydrogen ions (H+) and electrons (e) from water (H₂O), thereby having an acid property, and acryl, which is negatively charged, and the hydrogen ion (H+) react.

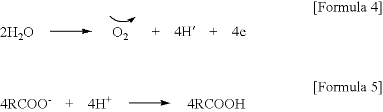

In Formula 5, R is a functional group containing carbon (C), oxygen (O), and hydrogen (H).

As described above, after polyimide is electro-deposited on the discharge electrode, the polyimide is hardened and thus a dielectric layer is formed. In detail, the hardening is performed first in a preliminary hardening process for about 10 minutes at about 90° C. and then in another hardening process for about another 30 minutes at about 200° C.

Accordingly, as the dielectric layer formed of an organic material is formed on the discharge electrode, the dielectric layer can be formed using a relatively low temperature process compared to a dielectric layer formed of an inorganic material that is formed using a high temperature plasticizing process. In addition, the dielectric layer can be formed to surround the discharge electrode regardless of the form of the discharge electrode.

FIG. 4 is a sectional perspective view illustrating a plasma display panel 100 according to an embodiment of the present invention.

Referring to FIG. 4, the plasma display panel 100 is a three-electrode surface discharge structure plasma display panel. The plasma display panel 100 includes first and second substrates 101 and 115, and barrier ribs 114 disposed between the first and second substrates 101 and 115 to define a plurality of discharge cells. The barrier ribs 114 here are striped-shaped, but the present invention is not limited thereto and the barrier ribs 114 may also be in other various forms such as a matrix or honey comb.

Also, sustain discharge electrode pairs 106 and 107 that are formed parallel to each other on the first substrate 101 and extend in a first direction and to which a predetermined voltage is applied to generate sustain discharge in the discharge cells are formed. An upper dielectric layer 109 covering the sustain discharge electrode pairs 106 and 107, and a protection layer 111 covering the upper dielectric layer 109 are also formed in the plasma display panel 100.

The upper dielectric layer 109 is formed of a first organic material that can be positively charged, such as polyimide, polyacryl, urea, melanine, or epoxy. For example, the sustain discharge electrode pairs 106 and 107 formed on the first substrate 101 may be connected to a cathode of an electro-deposition apparatus, and a counter-electrode facing the sustain discharge electrode pairs 106 and 107 may be connected to a anode of the electro-deposition apparatus, and then the sustain discharge electrode pairs 106 and 107 and the counter-electrode are immersed in a composition for electro-deposition in which polyimide and acryl are mixed in a solvent, and a predetermined voltage is applied to the anode and the cathode, and thus the upper sustain dielectric layer 109 formed of polyimide covering the sustain discharge electrode pairs 106 and 107 can be formed on the first substrate 101.

Also, the plasma display panel 100 includes on the second substrate 115, address electrodes 117 extending in a second direction to cross the sustain discharge electrode pairs 106 and 107, a lower dielectric layer 113 covering the address electrodes 117, and a phosphor layer 110 formed on the top surface of the lower dielectric layer 113 and on sides of the barrier ribs 114. The lower dielectric layer 113 is also formed of a second organic material that can be positively charged such as polyimide, polyacryl, urea, melanine, or epoxy. For example, when the address electrodes 117 formed on the second substrate 115 are connected to the cathode and a counter-electrode is connected to the anode, and then the address electrode 117 and the counter-electrode are immersed in a composition for electro-deposition in which polyimide and acryl are mixed in a solvent and a predetermined voltage is applied to each of the cathode and the anode, a lower dielectric layer 113 formed of polyimide can be formed on the second substrate 115 to cover the address electrodes 117.

After an organic material is electro-deposited on the sustain discharge electrode pairs 106 and 107 and the address electrodes 117 using the above electro-deposition coating method, the organic material such as polyimide is hardened to form the upper dielectric layer 109 and the lower dielectric layer 113. The hardening process can be performed by heating to a temperature of about 50 through about 250° C. at least once.

In the current embodiment of the present invention, the upper dielectric layer 109 and the lower dielectric layer 113 are formed of an organic material having a low dielectric rate and a greater dielectric withstand voltage than an inorganic material, and thus the thickness of the upper dielectric layer 109 and the lower dielectric layer 113 can be formed relatively thin to have a large discharge space. Typically, a dielectric layer formed of an inorganic material is formed to a thickness of 30 μm, but the upper dielectric layer 109 and the lower dielectric layer 113 according to the current embodiment of the present invention can be formed to a thickness of about 3 through about 100 μm. Also, the upper dielectric layer 109 and the lower dielectric layer 113 may be formed by hardening at a relatively low temperature of about 250° C. or less, and thus the first and second substrates 101 and 115 of the plasma display panel 100 may be formed of ceramics.

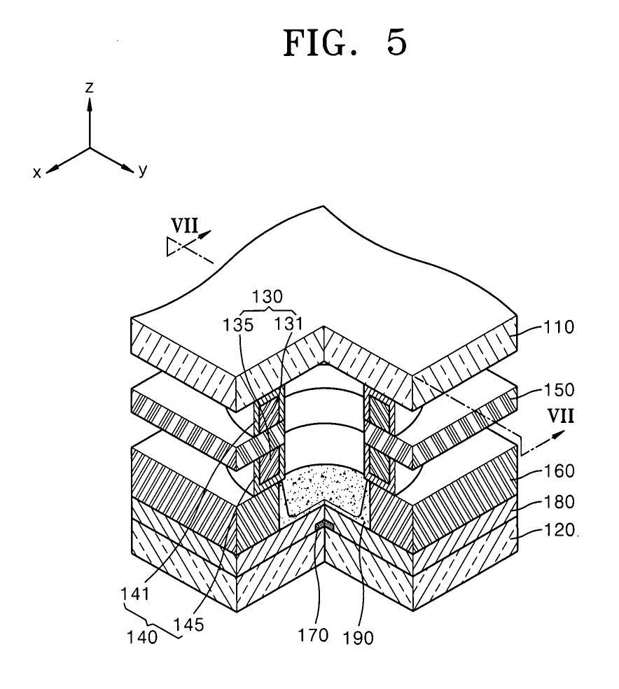

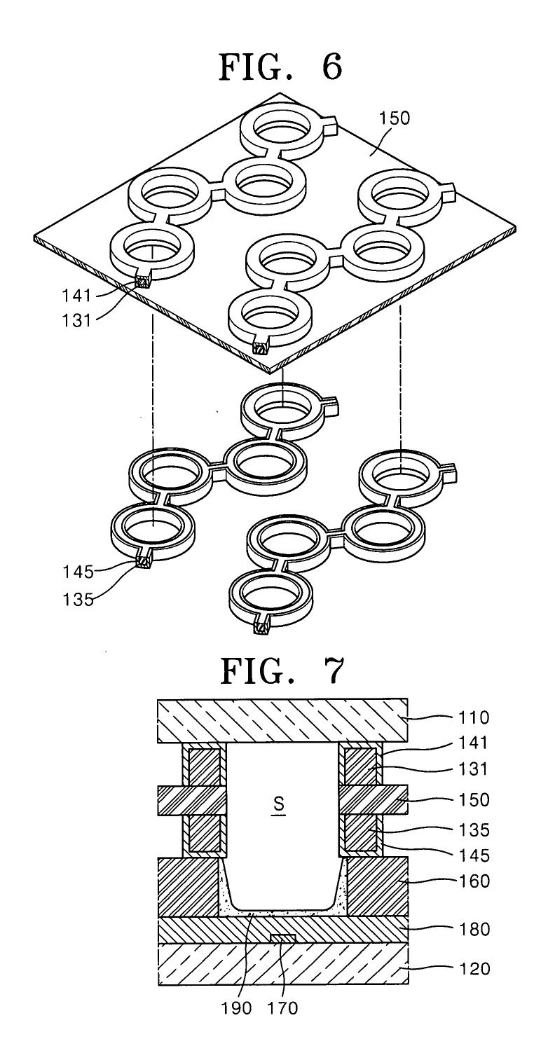

FIG. 5 is a partially cut perspective view illustrating a plasma display panel according to another embodiment of the present invention; FIG. 6 is an extended perspective view illustrating sustain discharge electrode pairs of the plasma display panel illustrated in FIG. 5, according to an embodiment of the present invention; and FIG. 7 is a cross-sectional view illustrating the plasma display panel of FIG. 5, according to an embodiment of the present invention.

Referring to FIG. 5, the plasma display panel includes first and second substrates 110 and 120 that are separated apart by a predetermined distance. A plurality of sustain discharge electrode pairs 130 are included between the first and second substrate 110 and 120, and the sustain discharge electrode pairs 130 include first sustain discharge electrodes 131 and second sustain discharge electrodes 135 that are arranged parallel to each other in a vertical direction.

Also, the first sustain discharge electrodes 131 and the second sustain discharge electrodes 135 are in contact with the front surface and rear surface of a third substrate 150, respectively. The third substrate 150 may be formed of an insulating film such as polyimide or ceramics.

Meanwhile, the first and second sustain discharge electrodes 131 and 135 include a plurality of circular opening portions, respectively, and the opening portions may be arranged in a zigzag formation, but the present invention is not limited thereto. Also, although the opening portions are illustrated to be circular in the current embodiment, the form of the opening portions is not limited thereto and may also be polygonal.

The sustain discharge electrode pairs 130 may be formed of a metal having excellent electric conductivity, for example, copper (Cu), in order to minimize heat radiation loss. The first and second sustain discharge electrodes 131 and 135 may be formed by forming a metal substrate having a predetermined thickness on the front and rear surfaces of the third substrate 150 and etching the metal substrate.

Also, the sustain discharge electrode pairs 130 are surrounded by an upper dielectric layer 140. The first and second sustain discharge electrodes 131 and 135 are formed to be adjacent to the front and rear surfaces of the third substrate 150 respectively, and thus first and second upper dielectric layers 141 and 145 are formed on a surface other than the surface to which the first and second sustain discharge electrodes 131 and 135 are adjacent to the third substrate 150. In the current embodiment, in particular, the first and second discharge electrodes 131 and 135 include circular opening portions, and thus the upper dielectric layer 140 is also formed inside the circular opening portions.

The upper dielectric layer 140 is formed of an organic material, such as polyimide, polyacryl, urea, melanine, and epoxy.

The upper dielectric layer 140 is formed on the sustain discharge electrode pairs 130 using the electro-deposition coating method described with reference to FIGS. 1 and 2. In detail; a composition for electro-deposition is manufactured by charging an organic material temporarily and the electro-deposited material such as the sustain discharge electrode pairs 130 is immersed in the composition for electro-deposition and electricity is applied to the material to coat the electro-deposited material with an organic material by electro-chemical reaction of the electro-deposited material and the charged organic material. For example, polyimide may be used as the organic material and acryl may be used as the counter-agent to prepare the composition for electro-deposition, and the first and second sustain discharge electrodes 131 and 135 formed of Cu and on the front and rear surfaces of the third substrate 150 and a counter-electrode facing the sustain discharge electrode pairs 130 are immersed in the composition for electro-deposition. The sustain discharge electrode pairs 130 are connected to a cathode of an electro-deposition apparatus, and the counter-electrode is connected to an anode of the electro-deposition apparatus and a predetermined voltage is applied, and thus the upper dielectric layer 140 is formed on the surface of the sustain discharge electrode pairs 130 exposed to the composition for electro-deposition. Here, the first upper dielectric layer 141 and the second upper dielectric layer 145 are formed to a thickness of about 3 to about 100 μm, respectively.

When a dielectric layer is formed on the first and second discharge electrodes 131 and 135 using a typical deposition method, a dielectric layer is not formed inside the opening portions or it is difficult to form the dielectric layer to a uniform thickness. However, using the electro-deposition coating method described with reference to FIGS. 1 and 2, the upper dielectric layer 140 can be formed on a surface of the sustain discharge electrode pairs 130 exposed by the composition for electro-deposition, that is, regardless of the form of the electrodes, and by electrochemical reaction into the opening portions, by applying a predetermined current to the sustain discharge electrode pairs 130.

Thus, the upper dielectric layer 140 blocks direct electric conduction between the first sustain discharge electrodes 131 or between the second sustain discharge electrodes 135 and prevents the sustain discharge electrode pairs 130 from being damaged by collision with charged particles that participate in discharging.

A plurality of discharge spaces are formed by the opening portions formed in corresponding positions of the first and second sustain discharge electrodes 131 and 135. In the current embodiment, the opening portions of the first and second sustain discharge electrodes 131 and 135 are arranged in a zigzag formation and thus the discharge spaces defined by the opening portions are also arranged in a zigzag formation.

An address electrode 170 is arranged on the second substrate 120, and a lower dielectric layer 180 is formed to cover the address electrode 170. One address electrode 170 is arranged for each discharge space. The lower dielectric layer 180 can be formed of an organic material using the above-described electro-deposition coating method. Examples of the organic material are polyimide, polyacryl, urea, melanine, and epoxy.

A barrier rib 160 corresponding to and partitioning the discharge spaces is formed on the lower dielectric layer 180, and the second upper dielectric layer 145 is formed on the barrier rib 160.

A phosphor layer 190 is coated on the barrier rib 160 and the lower dielectric layer 180. The phosphor layer 190 can include phosphor layers of different colors to realize a full-color display device. For example, when a color image is realized using the three basic colors of light, red, green, and blue, phosphors are coated alternately in the discharge spaces. Monochromatic light of red, green, or blue are emitted from each discharge space according to the type of the coated phosphors, and these form one color image.

Also, a discharge gas containing xenon (Xe), helium (He), etc., is injected into the discharge spaces.

FIG. 7 is a cross-sectional view of a discharge cell, and the second sustain discharge electrode 135, the third substrate 150, and the first sustain discharge electrode 131 are stacked in a vertical direction on the barrier rib 160, and the upper dielectric layer 140 surrounds the sustain discharge electrode pairs 130.

Hereinafter, a method of driving a plasma display panel according to an embodiment of the present invention will be described with reference to FIG. 7.

Referring to FIG. 7, by applying an alternating current to an arbitrary address electrode 170 and an arbitrary second sustain discharge electrode 135, a predetermined electric field that can generate discharge in a discharge space is formed and thus an address discharge is generated. Wall charges are accumulated in the selected discharge space due to the address discharge, and thus a difference in the inner voltage is created between the selected discharge space and the discharge space that is not selected. Then, when a critical voltage is applied alternately to the first and second sustain discharge electrodes 131 and 135, charged particles formed by ionization of the discharge gas move along a discharge path between the first and second sustain discharge electrodes 131 and 135, thereby generating a sustain discharge. The sustain discharge is generated in a looped curve along the vertical direction though lateral surfaces of the sustain discharge electrode pairs 130 that define the discharge space. In this respect, the lateral surfaces of the sustain discharge electrode pairs 130 become discharge surfaces. The discharge gas filled in the discharge spaces is excited by colliding with charged particles that move along the discharge path and drop to the base state and thus generate ultraviolet rays corresponding to the difference of the energy. The generated ultraviolet rays are converted into visible light through the phosphor layer 190 and the visible light is projected to the first substrate 110 and thus an image is realized.

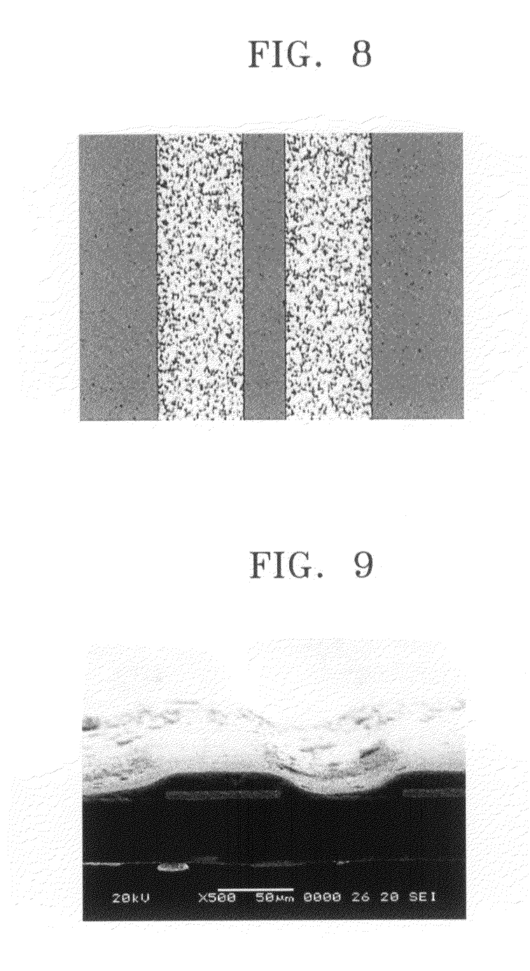

In the current embodiment, a plasma display panel using three types of electrodes such as the first and second sustain discharge electrodes 131 and 135, and address electrodes 170 is illustrated, but is not limited thereto, and a plasma display panel in which first and second sustain discharge electrodes 131 and 135 without an address electrode cross each other perpendicularly can also be realized. FIGS. 8 and 9 are photographic images showing the plasma display panel of FIG. 4 before and after forming the upper dielectric layer 109 and the lower dielectric layer 113.

FIG. 8 is a photographic image of the first substrate 101 of a surface discharge plasma display panel in which stripe type sustain discharge electrode pairs 106 and 107 are formed. Referring to FIG. 9, it can be seen that by forming the upper dielectric layer 109 formed of polyimide by the electro-deposition coating method on the first substrate 101, the upper dielectric layer 109 is formed to uniformly cover the sustain discharge electrode pairs 106 and 107.

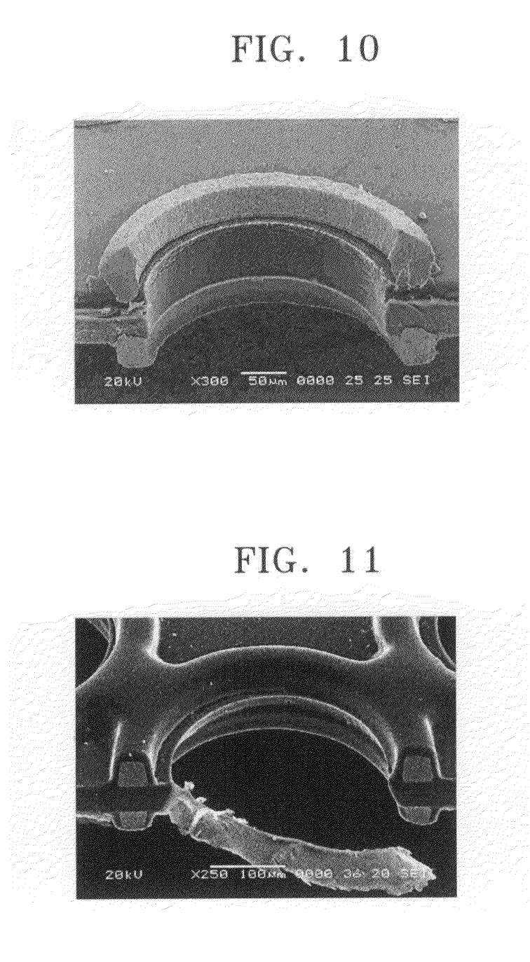

FIGS. 10 and 11 are photographic images showing the plasma display panel of FIG. 5 before and after forming the upper dielectric layer 140. FIG. 10 is a photographic image showing a cross-section of the sustain discharge electrode pairs 130 in which circular opening portions illustrated in FIG. 5 are formed. FIG. 11 illustrates a cross-section of the coated upper dielectric layers 140 formed of polyimide which surround the sustain discharge electrode pairs 130 including the circular opening portions using the electro-deposition coating method described with reference to FIGS. 1 and 2. In particular, the upper dielectric layer 140 is formed to a uniform thickness into the opening portions of the sustain discharge electrode pairs 130.

Accordingly, the present invention provides a method for forming a dielectric layer in a plasma display panel by an electro-deposition coating method of the present invention using an organic material. According to the invention, a dielectric layer can be formed that can coat an entire electrode regardless of the form of the electrode.

As described above, the present invention provides a dielectric layer of a plasma display panel, wherein the dielectric layer is formed of an organic material having a higher dielectric constant than an inorganic material. Thus, the dielectric layer can be formed to have a relatively small thickness covering a discharge electrode. This maximizes the discharge space and thus brightness and light emitting efficiency of the plasma display panel can be improved.

Also, the dielectric layer formed of an organic material can be formed using a relatively low temperature hardening process. Thus, the manufacturing process is simplified and the substrate of the plasma display panel can be formed of ceramics.

In addition, according to the present invention, the organic material is formed to be temporarily charged and a predetermined voltage is applied to the electrode, and thus a dielectric layer that can cover the entire discharge electrode regardless of the form of the discharge electrode can be formed on the discharge electrode by electrochemical reaction between the organic material and the electrode.

The plasma display panel including the dielectric layer according to the present invention can form a dielectric layer covering the discharge electrode regardless of the form of the discharge electrode and the brightness and the light emitting efficiency of the plasma display panel can be improved, thereby improving reliability of the plasma display panel. Also, the manufacturing cost can be reduced through the low temperature hardening process and the plasma display panel can be more easily manufactured by using ceramics.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A dielectric layer of a plasma display panel, wherein the dielectric layer is formed on a discharge electrode and comprises an organic material.

2. The dielectric layer of claim 1, wherein the organic material is one selected from the group consisting of polyimide, polyacryl, urea, melanine, and epoxy.

3. The dielectric layer of claim 1, wherein the glass transition temperature Tg of the organic material is at least 150° C.

4. A method of forming a dielectric layer of a plasma display panel on a discharge electrode using an electro-deposition coating method.

5. The method of claim 4, wherein the electro-deposition coating method comprises:
forming a composition for electro-deposition by mixing a counter-agent with an organic material;
immersing the discharge electrode and a counter-electrode facing the discharge electrode in the composition;
applying a voltage to the discharge electrode and the counter-electrode, respectively; and
electro-depositing the organic material on the discharge electrode.

6. The method of claim 5, wherein the composition for electro-deposition is formed by mixing 0.001-4.000 parts by weight of an organic material and 0.001-4.000 parts by weight of a counter-agent in a solvent.

7. The method of claim 5, wherein the organic material is one selected from the group consisting of polyimide, polyacryl, urea, melanine, and epoxy.

8. The method of claim 5, wherein the counter-agent is acryl.

9. The method of claim 5, further comprising hardening the electro-deposited organic material.

10. The method of claim 9, wherein the hardening is performed at a temperature in the range of 50-250° C.

11. A plasma display panel comprising:
first and second substrates separated from each other;
a plurality of discharge electrodes to which a predetermined voltage is applied to generate discharge in a discharge space between the first and second substrates;
a dielectric layer that is formed to cover the discharge electrodes and comprises an organic material; and
a phosphor layer located in the discharge space.

12. The plasma display panel of claim 11, wherein the organic material is one selected from the group consisting of polyimide, polyacryl, urea, melanine, and epoxy.

13. The plasma display panel of claim 11, wherein the discharge electrodes comprise sustain discharge electrode pairs arranged generally parallel to each other on the first substrate and extending in a first direction, and the dielectric layer is formed on the first substrate to cover the sustain discharge electrode pairs.

14. The plasma display panel of claim 11, wherein the discharge electrodes comprise sustain discharge electrode pairs disposed between the first and second substrates, and the dielectric layer is formed on the sustain discharge electrode pairs.

15. The plasma display panel of claim 14, wherein an opening portion is formed in each of the sustain discharge electrode, and the dielectric layer is formed on an inner surface of the opening portion of each of the sustain discharge electrodes.

16. The plasma display panel of claim 11, wherein the discharge electrodes comprise an address electrode extending in a second direction to which a voltage is applied to generate address discharge, and the dielectric layer is formed to cover the address electrode.
